(19) United States
(12) Patent Application Publication
(10) Pub. No.: US 2016/0203690 A1
(43) Pub. Date: Jul. 14, 2016

(54) EMERGENCY NOTIFICATION ASSEMBLY

(71) Applicant: Danyelle Marshall, San Leandro, CA (US)

(72) Inventor: Danyelle Marshall, San Leandro, CA (US)

(21) Appl. No.: 14/592,901

(22) Filed: Jan. 9, 2015

(51) Int. Cl. G08B 21/04; G08B 27/00

(52) U.S. Cl. CPC G08B 21/043; G08B 21/0446; G08B 27/001

(57) ABSTRACT

An emergency notification assembly includes a panel that has a top surface and a bottom surface. An adhesive is positioned on the bottom surface. The adhesive is coextensive with the bottom surface. The adhesive may adhere the panel to a user. A control circuit is positioned between the top surface and the bottom surface. The control circuit is in communication with an emergency responder. A motion sensor is positioned between the top surface and the bottom surface. The motion sensor is electrically coupled to the control circuit. The motion sensor may detect when the user has fallen to facilitate the control circuit alerting the emergency responder.

### BACKGROUND OF THE DISCLOSURE

### Field of the Disclosure

The disclosure relates to notification devices and more particularly pertains to a new notification device for notifying an emergency responder when a user has fallen.

### SUMMARY OF THE DISCLOSURE

An embodiment of the disclosure meets the needs presented above by generally comprising a panel that has a top surface and a bottom surface. An adhesive is positioned on the bottom surface. The adhesive is coextensive with the bottom surface. The adhesive may adhere the panel to a user. A control circuit is positioned between the top surface and the bottom surface. The control circuit is in communication with an emergency responder. A motion sensor is positioned between the top surface and the bottom surface. The motion sensor is electrically coupled to the control circuit. The motion sensor may detect when the user has fallen to facilitate the control circuit alerting the emergency responder.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an emergency notification assembly according to an embodiment of the disclosure.

FIG. 2 is a bottom view of an embodiment of the disclosure.

FIG. 3 is a top view of an embodiment of the disclosure.

FIG. 4 is a right side view of an embodiment of the disclosure.

FIG. 5 is a schematic view of an embodiment of the disclosure.

### DESCRIPTION OF THE PREFERRED EMBODIMENT

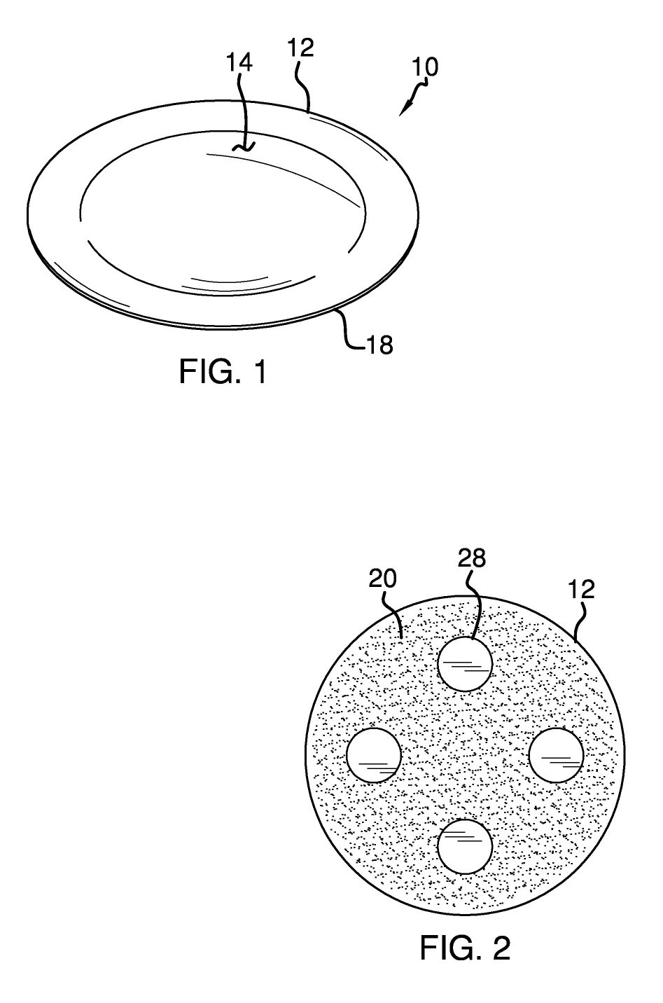

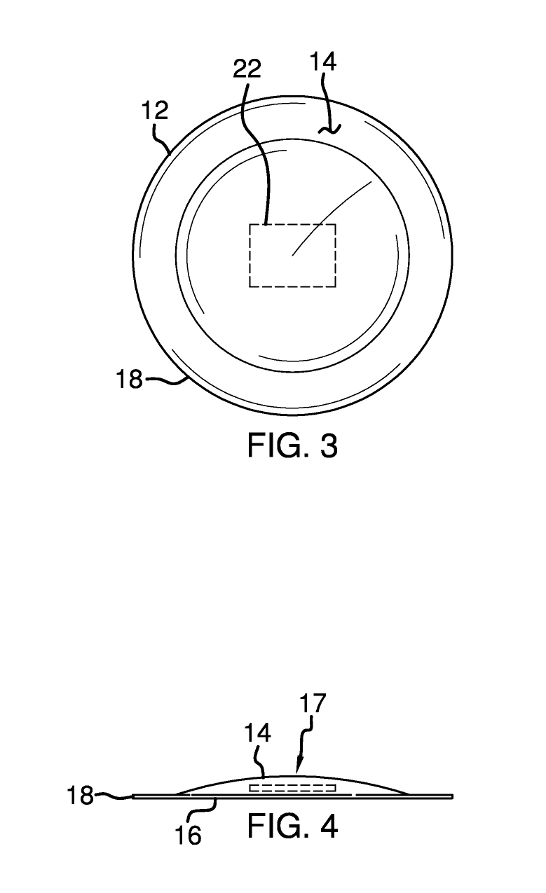

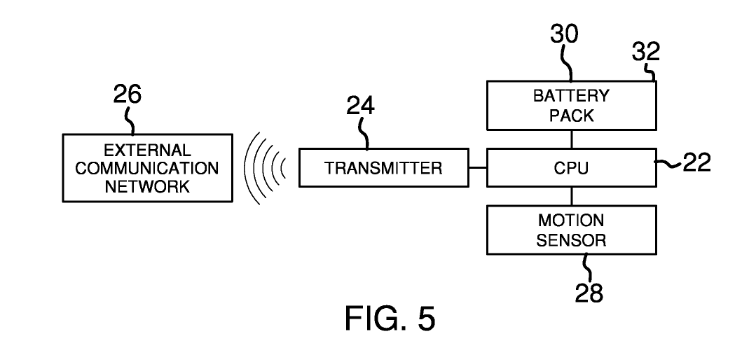

With reference now to the drawings, and in particular to FIGS. 1 through 5 thereof, a new notification device embodying the principles and concepts of an embodiment of the disclosure and generally designated by the reference numeral 10 will be described.

As best illustrated in FIGS. 1 through 5, the emergency notification assembly 10 generally comprises a panel 12 that has a top surface 14 and a bottom surface 16. The top surface 14 may be raised upwardly from the bottom surface 16 proximate a center 17 of the panel 12. The panel 12 has an outer edge 18 extending between the top 14 and bottom 16 surfaces. The outer edge 18 may be curved, giving the panel 12 a disk shape. An adhesive 20 is positioned on the bottom surface 16. The adhesive 20 is coextensive with the bottom surface 16. The adhesive 20 may adhere the panel 12 to a user. The adhesive 20 may be a non-residual and hypo-allergenic adhesive.

A control circuit 22 is positioned between the top surface 14 and the bottom surface 16. A transmitter 24 is positioned between the top surface 14 and the bottom surface 16. The transmitter 24 is electrically coupled to the control circuit 22. The transmitter 24 may be an RF transmitter of any conventional design.

The transmitter 24 may be in communication with an external communication network 26. The external communication network 26 may be a cellular phone network or the internet. The transmitter 24 may issue an alert to an emergency responder. The emergency responder may be local law enforcement or the like.

A motion sensor 28 is positioned between the top surface 14 and the bottom surface 16. The motion sensor 28 is electrically coupled to the control circuit 22. The motion sensor 28 may detect when the user has fallen to facilitate the transmitter 24 alerting the emergency responder. The motion sensor 28 may comprise an accelerometer. The accelerometer may have an operational range between 1.5 g and 3 g. Additionally, the motion sensor 28 may detect the user's orientation with respect to earth. The motion sensor 28 may detect when the user has moved from a vertical orientation with respect to earth into a horizontal orientation with respect to earth.

A power supply 30 is positioned between the top surface 14 and the bottom surface 16. The power supply 30 is electrically coupled to the control circuit 22. The power supply 30 comprises at least one battery 32.

In use, the panel 12 is worn by the user. The motion sensor 28 detects that the user has fallen. The transmitter 24 notifies the emergency responder that the user is in need of medical assistance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency notification assembly configured to issue a notification when a user has fallen, said assembly comprising:
a panel having a top surface and a bottom surface;
an adhesive positioned on said bottom surface, said adhesive being coextensive with said bottom surface, said adhesive being configured to adhere said panel to a user;
a control circuit positioned between said top surface and said bottom surface, said control circuit being in communication with an emergency responder; and
a motion sensor positioned between said top surface and said bottom surface, said motion sensor being electrically coupled to said control circuit, said motion sensor being configured to detect when the user has fallen to facilitate said control circuit alerting the emergency responder.

2. The assembly according to claim 1, wherein a transmitter positioned between said top surface and said bottom surface, said transmitter being electrically coupled to said control circuit, said transmitter being configured to be in communication with an external communication network, said transmitter being configured to issue an alert to an emergency responder.

3. The assembly according to claim 1, wherein a power supply positioned between said top surface and said bottom surface, said power supply being electrically coupled to said control circuit, said power supply comprising at least one battery.

4. An emergency notification assembly configured to issue a notification when a user has fallen, said assembly comprising:
a panel having a top surface and a bottom surface;
an adhesive positioned on said bottom surface, said adhesive being coextensive with said bottom surface, said adhesive being configured to adhere said panel to a user;
a control circuit positioned between said top surface and said bottom surface;
a transmitter positioned between said top surface and said bottom surface, said transmitter being electrically coupled to said control circuit, said transmitter being configured to be in communication with an external communication network, said transmitter being configured to issue an alert to an emergency responder;
a motion sensor positioned between said top surface and said bottom surface, said motion sensor being electrically coupled to said control circuit, said motion sensor being configured to detect when the user has fallen to facilitate said transmitter alerting the emergency responder; and
a power supply positioned between said top surface and said bottom surface, said power supply being electrically coupled to said control circuit, said power supply comprising at least one battery.
